(19) United States
(12) Patent Application Publication
(10) Pub. No.: US 2003/0026939 A1
(43) Pub. Date: Feb. 6, 2003

(54) Core guide assembly for stationery article

(76) Inventor: Sun-Hyung Lee, Daejeon-city (KR)

Correspondence Address: HARNESS, DICKEY & PIERCE, P.L.C., P.O. BOX 8910, RESTON, VA, 20195, US

(21) Appl. No.: 10/010,353

(22) Filed: Nov. 13, 2001

(30) Foreign Application Priority Data
Aug. 2, 2001 (KR) U.M. 2001-23500

(51) Int. Cl. B32B 3/06

(52) U.S. Cl. 428/99

(57) ABSTRACT

A core guide assembly for a stationery article includes a screw member with a predetermined length while externally bearing a male screw. A support member is connected to the one-sided end of the screw member while centrally bearing a support bar protruded opposite to the screw member. The support bar has a support wing protruded in the radial direction. The support wing has portions placed at the same plane, or arranged by two or more steps.

### BACKGROUND OF THE INVENTION

(a) Field of the Invention

The present invention relates to a core guide assembly for a stationery article and, more particularly, to a core guide assembly for a stationery article which prevents separation of a core by way of a support wing.

(b) Description of the Related Art

A stationary article such as a glue, an eraser, a crayon and a pencil may be provided with a core guide assembly for guiding a bar-shaped core such that the core can be gradually exposed to the outside for use.

As shown in FIGS. 1 and 2, the stationery article includes a tube case 2 both ends of which are in an opening state, a bar-shaped core 1 mounted within the tube case 2, a rotation unit 4 fitted to the one-sided end of the tube case 2 such that it can be rotated, and a core guide assembly 10 inserted into the tube case 2 such that it can move along the inner surface of the tube case 2 in the longitudinal direction. For instance, the bar-shaped core may be a glue stick.

The movement of the core guide assembly 10 is made by way of clockwise and anticlockwise rotations of the rotation unit 4, and the one-sided end of the core guide assembly 10 partially supports the core 1.

A cap 8 is externally fitted to the other-sided end of the tube case 2 such that it can intercept the core 1 from the outside. The cap 8 has a clip 9 for holding the article to a coat collar, or a pocket collar.

The rotation unit 4 includes a rotation member 5 fitted to the one-sided end of the tube case 2 such that it can be rotated, and an operation member 6 inserted into the tube case 2 such that it can be rotated together with the rotation member 5. The operation member 6 mounts the core guide assembly 10 therein.

The core guide assembly 10 has a screw member 11 externally bearing a male screw, and a support member 12 moving together with the screw member 11 while partially supporting the core 1.

One or more operation protrusions 7 are internally formed at the operation member 6 of the rotation unit 4 such that they are inserted into the grooves of the screw member 11.

A guide groove 13 is longitudinally formed at the lateral side of the support member 12, and a guide protrusion 3 is formed at the inner surface of the tube case 2 such that it is inserted into the guide groove 13. The guide protrusion 3 guides the movement of the core guide assembly 10 in the longitudinal direction while prohibiting the rotation thereof.

When the rotation unit 4 is rotated with the formation of the operation protrusions 7 and the guide protrusion 3, the operation member 6 is rotated in its own place because it is fitted to the tube case 2 while being prohibited in its movement in the longitudinal direction. Since the core guide assembly 10 where the screw member 11 thereof is fitted to the operation protrusions 7 is prohibited in its rotation by way of the guide protrusion 3, the core guide assembly 10 performs its guiding operation while moving back and forth pursuant to the rotation of the rotation unit 4.

As the core guide assembly 10 performs its guiding operation, the core 1 held by the support member 12 of the core guide assembly 10 is exposed to the outside, or intercepted from the outside.

A plurality of support protrusions 14 are formed at the inner surface of the support member 12 of the core guide assembly 10 to support the core 1.

The core 1 occupying the charge space 15 of the support member 12 is partially held by the support protrusions 14, and moves together with the core guide assembly 10. The core 1 is partially influenced by the elastic force of the support member 12 that suffers expansion and contraction during the charge of the core 1.

In operation, when the core guide assembly 10 moves forward pursuant to the rotation of the rotation unit 4, the core 1 is pushed upward by way of the support member 12 so that the movement of the core 1 can be made in a smooth manner.

However, when the core guide assembly 10 moves backward, the core 1 also moves while being influenced by the elastic force of the support member 12 of the core guide assembly 10, and held by the support protrusions 14. In case the core 1 is formed with a soft material such as a solid paste, the core 1 is deformed due to the abrasion force occurring between the core 1 and the tube case 2 so that it slides over the support protrusions 14. In this case, the core 1 is separated from the support member 12 so that the backward movement thereof cannot be made.

Particularly, in case the diameter of the core 1 is 10 mm or less, the supporting power of the support protrusions 14 becomes reduced, and this facilitates the separation of the core 1 from the support member 12.

When the core 1 is separated from the support member 12 and the backward movement thereof is not made, the end portion of the core 1 is largely exposed to the outside of the tube case 2. In this state, when the cap 8 is closed, the core 1 is partially attached to the cap 8 while being deformed in its shape and contaminating the surroundings.

### SUMMARY OF THE INVENTION

It is an object of the present invention to provide a core guide assembly for a stationery article which has a cylinder-shaped support bar externally bearing a support wing to support a core in a stable manner.

This and other objects may be achieved by a core guide assembly for a stationery article with the following features.

The core guide assembly includes a screw member with a predetermined length while externally bearing a male screw. A support member is connected to the one-sided end of the screw member while centrally bearing a support bar protruded opposite to the screw member. The support bar has a support wing protruded in the radial direction.

The support wing has arc-shaped portions placed at the same plane, or arranged by two or more steps. The arced angle of the support wing is established to be 30-120°. It is preferable that the arced angle of the support wing is established to be 90° or less.

In case the support wing is formed with two or more stepped portions, the portions thereof are arranged in a zigzag.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or the similar components, wherein:

FIG. 1 is a cross sectional view of a usual stationery article;

FIG. 2 is a cross sectional view of a core guide assembly for the stationery article shown in FIG. 1;

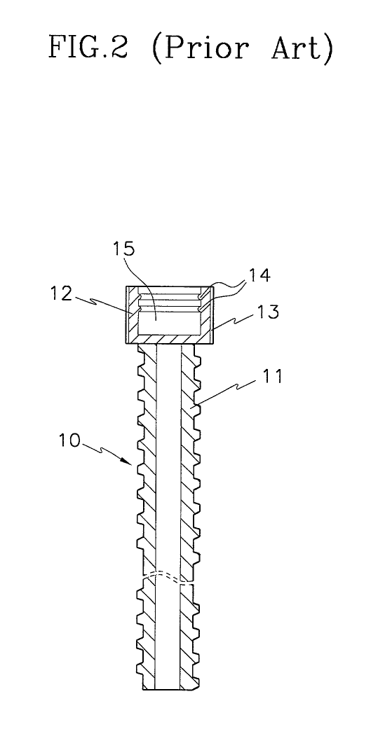

FIG. 3 is a side view of a core guide assembly for a stationery article according to a first preferred embodiment of the present invention;

FIG. 4 is a plan view of the core guide assembly shown in FIG. 3;

FIG. 5 is a side view of a core guide assembly for a stationery article according to a second preferred embodiment of the present invention;

FIG. 6 is a side view of a core guide assembly for a stationery article according to a third preferred embodiment of the present invention;

FIG. 7 is a side view of a core guide assembly for a stationery article according to a fourth preferred embodiment of the present invention; and

FIG. 8 is a side view of a core guide assembly for a stationery article according to a fifth preferred embodiment of the present invention.

### DETAILED DESCRIPTION OF THE PREFERRED EMBODIMENTS

Preferred embodiments of this invention will be explained with reference to the accompanying drawings.

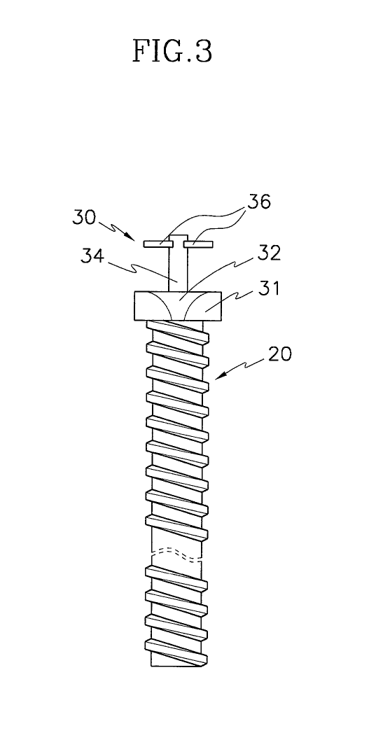

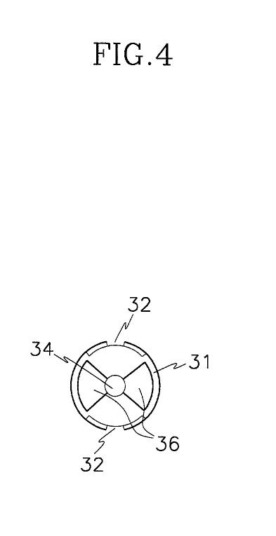

FIG. 3 is a side view of a core guide assembly for a stationery article according to a first preferred embodiment of the present invention, and FIG. 4 is a plan view of the core guide assembly shown in FIG. 3.

As shown in FIGS. 3 and 4, the core guide assembly includes a screw member 20 with a predetermined length while externally bearing a male screw, and a support member 30 connected to the one-sided end of the screw member 20. The support member 30 has a support bar 34 protruded opposite to the screw member 20, and a support wing 36 protruded from the support bar 34 in the radial direction.

The support member 30 further has a disk-shaped support plate 31 from which the screw member 20 and the support bar 34 proceed up and downward.

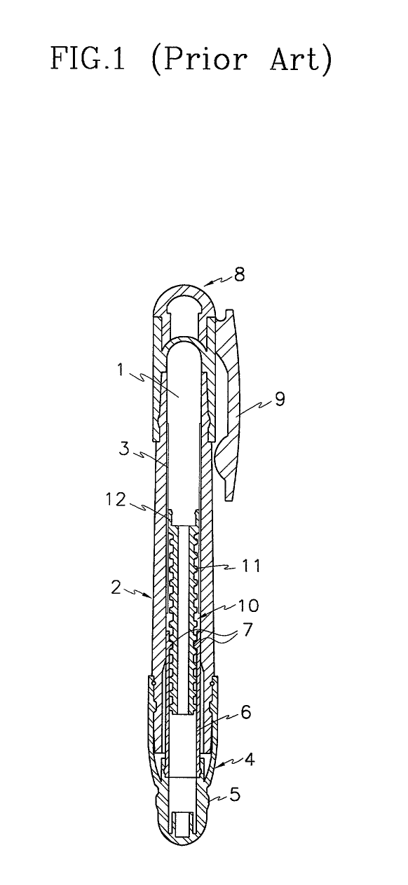

A guide groove 32 is formed at the circumference of the support plate 31. The guide protrusion 3 previously described with reference to FIG. 1 is inserted into the guide groove 32.

As with the previously described guide groove 13, the guide groove 32 prohibits the rotation of the core guide assembly, and makes the core guide assembly move back and forth. The movement of the core guide assembly is made by way of the screwing operation between the screw member 20 and the operation protrusions 7 formed at the operation member 6 of the rotation unit 4.

As shown in FIG. 4, the support wing 36 has arc-shaped portions with a predetermined angle. The arced angle of the support wing 36 is preferably established to be in the range of 30-120°.

When the arced angle of the support wing 36 is smaller than 30°, the supporting power thereof is too weak. In contrast, when the arced angle of the support wing 36 is greater than 120°, it becomes difficult to produce it through injection molding in a type of partitioned molding.

Therefore, it is preferable that the arced angle of the support wing 36 should be established to be in the range of 30-120°, more preferably in the range of 60-90°.

The support wing 36 is established to proceed normal to the support bar 34.

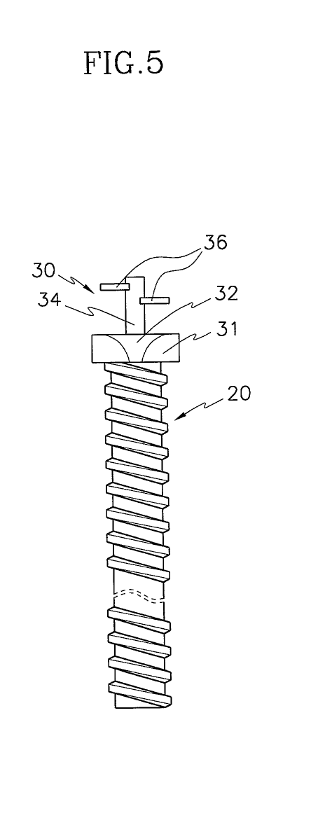

As shown in FIG. 5, the support wing 36 may be formed with two or more stepped portions.

In case the support wing 36 has two or more stepped portions, the stepped portions of the support wing 36 may be arranged in a zigzag such that they are protruded in the directions opposite to each other.

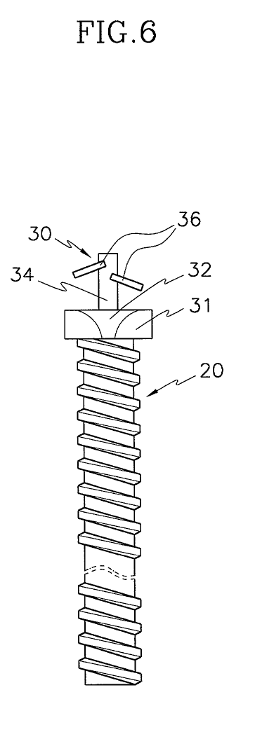

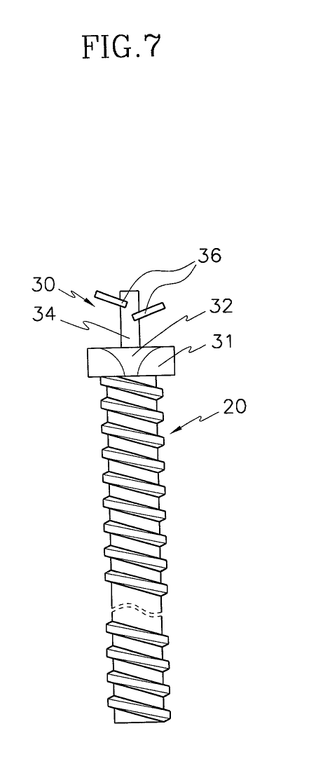

As shown in FIGS. 6 and 7, the portions of the support wing 36 may be angled with respect to the support bar 34 by 90° or less, for example, by 30°, 45° or 60°.

It is preferable that the support wing 36 is angled with respect to the support bar 34 by 30-90°.

When the angle between the support wing 36 and the support bar 34 is less than 30°, the supporting power thereof becomes reduced while making it possible for them to penetrate into the bar-shaped core 1.

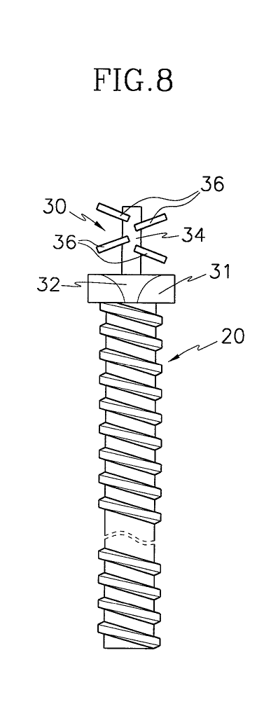

In case the angle between the support wing 36 and the support bar 34 is established to be 90° or less, as shown in FIG. 8, it becomes possible for the support wing 36 to have a upward-inclined portion and a downward-inclined portion in a combinatorial form.

The above-structured core guide member may be well applied for use in the stationery article shown in FIG. 1. When the rotation unit 4 is rotated in the normal direction to move the core 1 forward, the core 1 is pushed upward by way of the support wing 36 and the support plate 31. When the rotation unit 4 is rotated in the reverse direction to move the core 1 backward, the core 1 is pulled by the support wing 36 while being supported thereby.

The support wing 36 bears a large volume in the radial direction with respect to the core 1, and the core 1 is partially existent under the support wing 36. Accordingly, the core 1 moves by way of the pressure of the support wing 36.

As described above, the bar-shaped core is supported by the support wing during its movement so that the separation thereof from the support member can be prevented while making the core guiding operation in a smooth manner.

The bar-shaped core is safely positioned within the tube case for storage so that damage thereof or contamination of the cap does not occur.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A core guide assembly for a stationery article comprising:
a screw member with a predetermined length while externally bearing a male screw; and
a support member connected to the one-sided end of the screw member while centrally bearing a support bar protruded opposite to the screw member, the support bar having a support wing protruded in the radial direction.

2. The core guide assembly of claim 1 wherein the support wing is arc-shaped with an angle of 30-120°.

3. The core guide assembly of claim 1 wherein the support wing is angled with respect to the support bar by 30-90°.

4. The core guide assembly of claim 1 wherein the support wing has portions arranged by two or more steps.

5. The core guide assembly of claim 1 wherein the support wing has two or more stepped portions arranged in a zigzag such that the portions are protruded in the directions opposite to each other.
